(19) United States
(12) Patent Application Publication
(10) Pub. No.: US 2015/0119505 A1
(43) Pub. Date: Apr. 30, 2015

(54) Paper Coating Composition

(71) Applicants: Edward Scott Williams, Charlotte, NC (US); Alicia B. Richards, Charlotte, NC (US)

(72) Inventors: Edward Scott Williams, Charlotte, NC (US); Alicia B. Richards, Charlotte, NC (US)

(21) Appl. No.: 14/527,271

(22) Filed: Oct. 29, 2014

Related U.S. Application Data
(60) Provisional application No. 61/896,676, filed on Oct. 29, 2013.

(51) Int. Cl. C09D 103/08

(52) U.S. Cl. CPC C09D 103/08
USPC 524/50; 106/2

(57) ABSTRACT

A process for producing an oil and grease resistant paper product comprising the steps of preparing a paper coating composition to the paper product, the paper coating composition comprising one or more polysaccharides, one or more solvents and one or more bases.

### RELATED CASES

This application claims the priority of the provisional application Ser. No. 61/896,676 filed Oct. 29, 2013. Applicant hereby incorporates by reference the entire content of provisional application Ser. No. 61/896,676.

### FIELD OF THE INVENTION

The present invention relates to a composition which enhances the barrier properties of paper based products.

### BACKGROUND OF THE INVENTION

The barrier properties of paper based products may be enhanced by a variety of compounds which are known in the art. It is well known in the art that various polysaccharide compositions have been used as additives in the production of paper and paper products. For example, starch compositions have been used in the production of paper products for purposes of strength enhancement, ease of printing, quality of printing, and other purposes. It is desirable to provide polysaccharide compositions that may be useful in the production of paper products that have oil and grease resistance, in addition to having release properties. The resulting paper products having the characteristics of oil and grease resistance, and/or release properties have utility in many applications. Among those applications, the paper products could be useful in food packaging, oil and grease resistant food containers, and release paper for frozen foods, among other uses.

There is currently a migration away from existing barrier product technology, particularly perfluorochemicals (PFCs), due to both their biopersistence and their environmental persistence. Products based on PFCs are believed to leach chemicals into the environment and also lack the ability to be recycled and/or repulped. The same can be said for persistent organic pollutants (POPs) which are organic compounds that are resistant to environmental degradation through chemical, biological and photolytic processes. POPs are characterized by low water solubility, high lipid solubility, semi-volatility, high molecular mass, and stability. This allows for bioaccumulation in fatty tissues of living organisms and slow metabolism, which confers the compound's persistence and accumulation into chains. Halogenation with chlorine, bromine, and fluorine and aromatic rings resist hydrolysis. The greater the number of halogen substitutions, the greater resistance to biological and photolytic degradation, resulting in POPs' stability and environmental persistence. The use of traditional coatings also results in significant product limitations. Abstaining from these traditional coatings, the use of water-based emulsions in combination with natural co-binders has allowed for the development of a bio-based and biodegradable grease resistant paper which is also 100% recyclable and repulpable.

This invention relates to barrier coatings providing oil and grease resistance to paper and paperboard substrates. This invention also relates to recyclable coatings having oil and grease resistant properties and products prepared by application of such coatings to paper and paperboard substrates.

It is clear that a need exists to provide a barrier coating for paper and paperboard substrates which is oil and grease resistant, FDA compliant and which may be useful in food packaging.

### SUMMARY OF THE INVENTION

A process for producing an oil and grease resistant paper product comprising the steps of preparing a paper coating composition for the paper product, the paper coating composition comprising one or more polysaccharides, one or more solvents and one or more bases.

### DESCRIPTION OF THE DRAWINGS

FIG. 1 is a graph regarding viscosity of the OSA Polysaccharide

FIG. 2 is a graph regarding oil and grease resistance

FIG. 3 is a graph regarding viscosity of the OSA Polysaccharide

### DETAILED DESCRIPTION

The articles and methods described herein may be understood more readily by reference to the following detailed description and the examples provided therein. It is to be understood that this invention is not limited to the specific components, articles, processes and/or conditions described, as these may, of course, vary. It is also to be understood that the terminology used herein is for the purpose of describing particular embodiments only and is not intended to be limiting.

The invention disclosed herein describes a polysaccharide composition for producing a lower, more operative viscosity and maintaining and/or improving Kit performance comprising one or more polysaccharides, one or more solvents, water and one or more bases.

Polysaccharide, as used herein, refers to polymeric carbohydrate molecules composed of long chains of monosaccharide units bound together by glycosidic linkages and on hydrolysis give the constituent monosaccharides or oligosaccharides. Polysaccharide range in structure from linear to highly branched. Examples include storage polysaccharides such as starch and glycogen, and structural polysaccharides such as cellulose and chitin. Cellulose is used in the cell walls of plants and other organisms, and is said to be the most abundant organic molecule on earth. It has many uses such as a significant role in the paper and textile industries. Chitin has a similar structure, but has nitrogen-containing side branches, increasing its strength. The polysaccharides are blended together in a mixer at a speed of 100 to 3000 rpm in order to achieve a desired viscosity and Kit level. The polysaccharides may also be blended together in a mixer at a speed of 500 to 2800, 900 to 2600 or 1100 to 2400 rpm in order to achieve a desired viscosity and Kit level. The polysaccharides are blended together in a mixer using a low shear mixing head. Polysaccharides include corn, maize, waxy maize, cassava, rice, soy, potato, wheat, or any other polysaccharide known in the art.

Solvents, as used herein, refers to a substance which dissolves a solute (a chemically different liquid, solid or gas), resulting in a solution. Solvents include water, alcohols, ethers, acids and other organic compounds in solution with water. In one embodiment of the present invention, the solvent is an organic solvent is selected from the group including, but not limited to, methanol, ethanol, isopropyl alcohol, n-propanol, tetrahydrofuran, dimethyl sulfoxide, butanol or any combination of these organic solvents in a water solution. In another embodiment of the present invention, the solvent is selected from the group including, but not limited to, water, methanol, ethanol, isopropyl alcohol, n-propanol, tetrahydrofuran, dimethyl sulfoxide, butanol or any combination of these organic solvents in a water solution. In yet another embodiment, the solvent is present in only a trace amount. In still another embodiment, the solvent is not present.

Base, as used herein, refers to a substance which can accept a hydrogen ion (H+) from another substance. Bases may also be considered as any substance having a pH greater than 7.0. In one embodiment of the present invention, the base is selected from the group including, but not limited to, sodium hydroxide, sodium carbonate, sodium bicarbonate, potassium hydroxide, calcium hydroxide, magnesium hydroxide, or any combination thereof. In one embodiment of the present invention, the base or base solution is present in only trace amounts.

The polysaccharides used in the instant invention are modified using an alkenyl succinic anhydride (ASA) (i.e. substituting ASA onto the backbone of the polysaccharide). Alkenyl succinic anhydride, as used herein, refers to a material commonly used as a sizing agent in the paper making industry. In one embodiment of the instant invention, the alkenyl succinic anhydride has a monounsaturated alkene chain with 3, 4, 5, 6, 7, 8, 9, 10, 12, 14, 16, 18, 20, 22 or 24 carbon atoms. In another embodiment of the instant invention, the alkenyl succinic anhydride has a monounsaturated alkene chain with 3-5 carbon atoms, 6-18 carbon atoms, 19-24 carbon atoms, 3-24 carbon atoms, or a combination thereof. An ASA modified polysaccharide starch is a hydrophobically modified starch. Additional hydrophobically modified polysaccharides may also be used in the instant invention. These include, but are not limited to, ethoxylated polysaccharides, hydroxypropylated polysaccharides, hydroxbutylated polysaccharides, or combinations thereof.

In one embodiment of the instant invention, the polysaccharide is a blend of low molecular weight polysaccharides and high molecular weight polysaccharides. In another embodiment, the low molecular weight polysaccharides have a molecular weight in the range of 10² to 10⁶ Daltons and the high molecular weight polysaccharides have a molecular weight in the range of 10⁶ to 10¹⁰ Daltons. In still another embodiment of the present invention, the polysaccharide has a molecular weight in the range of 10² to 10¹⁰ Daltons, 10³ to 10⁸ Daltons, 10⁴ to 10⁷ Daltons, or a combination thereof. In yet another embodiment, the composition achieves a viscosity level of 300 cps or less and a Kit level of 6 or more at a temp of 80-120° F. In still another embodiment, when combining one or more polysaccharides having a viscosity in the range of 600 to 800 with one or more polysaccharides having a viscosity in the range of 50 to 200 the composition unexpectedly achieves a viscosity level in the range of 50 to 350 cps, 100 to 300 cps, 150 to 250 cps, or 200 cps. The same blends achieve a Kit range of 3-12, 4-12, 5-12, 6-12, 7-12, 8-12, 9-12, 10-12, or any combination thereof.

The polysaccharide composition of the instant invention includes one or more polysaccharides which is an alkenyl succinic anhydride modified polysaccharide, an un-modified polysaccharide, or a combination thereof. In another embodiment of the instant invention, the solvent is selected from the group including an organic solvent, water, or a combination thereof and where water includes tap water, distilled water, deionized water, filtered water, or a combination thereof.

The invention disclosed herein describes a process for producing an oil and grease resistant product or paper product comprising the steps of: preparing a paper coating composition for application to the paper product, the paper coating composition comprising one or more polysaccharides, one or more solvents, and one or more bases.

Oil and grease resistant (OGR), as used herein, refers to products or paper products which have a Kit test rating of at least 1. In another embodiment of the instant invention, oil and grease resistant refers to products or paper products which have a Kit test rating of at least 2. In yet another embodiment, oil and grease resistant refers to products or paper products which have a Kit test rating of at least 3. In still another embodiment, the oil and grease resistance of the product or paper product is in the Kit range of 3-14, 3-12, 4-12, 5-12, 6-12, 7-12, 8-12, 9-12, 10-12, or any combination thereof. The level of grease resistance of a paper product may depend on how the coating composition was applied (i.e. immersion, metering rod, slot die, spraying, gap, roller, padding, blade, flooded nip or puddle size press, or a combination thereof). The grease resistant products/paper products described above are useful for forming into containers for oil and/or grease containing items. Hence, the materials used to form those products must be approved for contact with food and food related items.

Paper product, as used herein, refers to any material produced by pressing moist fibers (i.e. cellulose pulp) derived from plant materials. Paper products may include paper of any thickness or basis weight, corrugated board, paperboard, or any combination thereof. The paper coating composition may be applied to a product or paper product using any method known in the industry including, but not limited to, immersion, rolling, spraying, padding or a combination thereof).

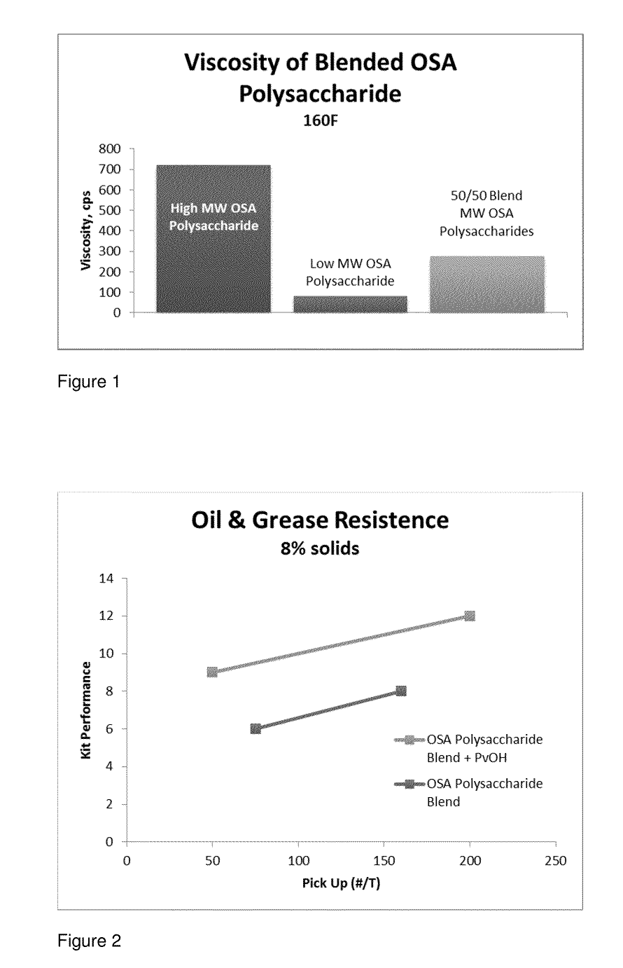

One key aspect of the instant invention is the blend of multiple viscosities of modified polysaccharide which produce lower viscosity and maintains or improve Kit performance. This is important because flooded nip/pond/puddle size presses require lower viscosity solutions to function properly. High molecular weight polysaccharides produce optimum coating/sizing coverage, but unless used at low solids levels, produce high viscosity that precludes their use in many size press operations. At the other end of the spectrum, low solids fail to provide adequate Kit performance in OGR applications. The instant invention, as illustrated in FIG. 1, allows a higher solids formulation which has sufficiently low viscosity to allow good Kit performance and runnability on conventional size presses.

The viscosity range for un-modified polysaccharides is approximately 10-800 centipoise at 120° F. The viscosity range of un-modified tapioca starch is in the range of 300 to 800 centipoise at 120° F.

Low molecular weight polysaccharides alone result in a product that meets the necessary viscosity specification, but does not meet the OGR requirements. In contrast, full molecular weight polysaccharide alone gives the necessary OGR, but have a higher viscosity than is needed for the application. Blending the modified polysaccharides with various molecular weights (low, medium and high molecular weight) and mixing them in a specific fashion (explained below) results in a product that achieves both the viscosity and OGR requirements at a higher solids content than would otherwise be possible. The viscosity of these blends is surprisingly lower than would be expected from the calculated addition of two materials with given viscosities.

One unexpected result realized by the instant invention was that the addition of a hydrophilic polyvinyl alcohol (PvOH) to a hydrophobic polysaccharide improves Kit performance. Persons having skill in the art would know that oil and grease resistance typically requires a hydrophobic film on the operative surface of the product or paper product. However, the instant invention has discovered that the addition of a hydrophilic additive, (i.e. PvOH), surprisingly enhances OGR Kit performance as is illustrated in Table 2 below. One having skill in the art would realize the synergistic effect that the addition of the PvOH achieves from the illustration of FIG. 2.

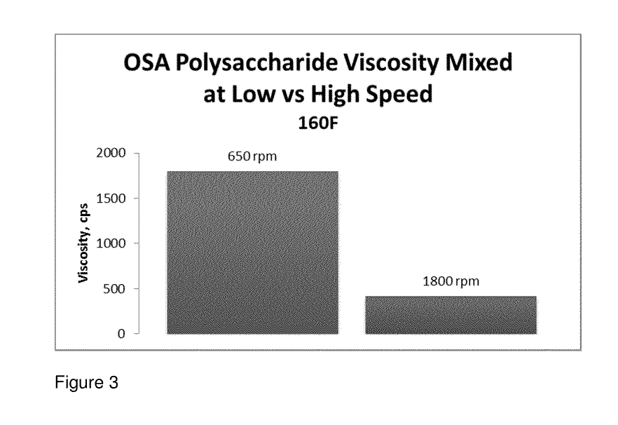

Another key aspect of the instant invention is the preparation of the hydrophobic polysaccharide for use in the sizing of paper products. Increasing the speed of mixing allows lower viscosity while maintaining or improving Kit performance. Stated differently, increasing the mixing speed from 650 rpm to 1800 rpm enables enhanced emulsification of the solution while maintaining the integrity of the polysaccharide backbone. This promotes better film formation on the paper surface but also reduces the final viscosity of the mix (illustrated in FIG. 3).

The instant invention relates to a method of preparing hydrophobic polysaccharide that allows a lower viscosity solution to be prepared which supports the OGR paper coating composition and allows higher solids solutions to be used in lower viscosity requirement applications in paper sizing.

The invention disclosed herein also involves a paper coating composition that provides improved barrier properties for the coated paper. Coating composition, as used herein, refers to both a coating and surface sizing composition for paper. Barrier properties refer to an increase in the resistance of the paper to materials including water, oil and grease. The instant invention is fluorochemical free due to the potential issues surrounding its biopersistence, environmental persistence and changes in food regulations.

One embodiment of the present invention describes a paper coating composition for providing improved barrier properties comprising one or more hydrophobically modified polysaccharides, one or more solvents and one or more bases. The hydrophobically modified polysaccharide can be modified with any alkenyl succinic anhydrides and may have a monounsaturated alkene chain with 3, 4, 5, 6, 7, 8, 9, 10, 12, 14, 16, 18, 20, 22 or 24 carbon atoms. The alkenyl succinic anhydride polysaccharide may also have 3-5 carbon atoms, 6-18 carbon atoms, 19-24 carbon atoms, 3-24 carbon atoms or a combination thereof.

In yet another embodiment, the solvent is present in only trace amounts and the base is present in only trace amounts. In still another embodiment, the organic solvent is selected from the group including, but not limited to, methanol, ethanol, isopropyl alcohol, n-propanol, tetrahydrofuran, dimethyl sulfoxide, butanol or any combination of these organic solvents in a water solution. In yet another embodiment, the polysaccharide has a molecular weight in the range of 10² to 10¹⁰ Daltons, 10³ to 10⁸ Daltons, 10⁴ to 10⁷ Daltons, or a combination thereof. In still another embodiment, the base is selected from the group including, but not limited to, sodium hydroxide, sodium carbonate, sodium bicarbonate, potassium hydroxide, calcium hydroxide, magnesium hydroxide, or any combination thereof.

The products and methods described herein generally relate to environmentally safe, oil and grease resistant products and methods. The reduction of environmental hazards is a focal point in the development of new industrial chemicals and processes associated with the chemicals and/or processes. The industrial use of hazardous material results in increased manufacturing costs in addition to the direct health implications of toxic materials. The grease resistant products, coatings, and methods for manufacture described in the instant application employ materials significantly less hazardous to people and the environment than those currently used in the industry, most notably, fluorocarbons. Moreover, the coatings and coated products described herein neither contaminate nor impede recycling processes.

The present invention includes:
1) A Blend of Hydrophobically Modified Polysaccharides
2) A Blend of Hydrophobically Modified Polysaccharides enhanced by polyvinyl alcohol.
3) A method of physically blending Hydrophobically Modified Polysaccharides and Hydrophobically Modified Polysaccharides enhanced by polyvinyl alcohol.

### Physical Blend:

The product can be made by physically mixing multiple hydrophobically modified polysaccharides made from any of the following base materials: corn starch, waxy maize starch, tapioca or cassava starch, potato starch, rice starch, and cellulose. The substitution levels of the hydrophobe on the base starch can be in the range of 0.1-50%, preferably in the range of 1 to 40%, more preferably in the range of 2 to 30% and most preferably in the range of 3 to 25%. The hydrophobic substituent can be any of the alkenyl succinic anhydrides with carbons numbering 3-24.

Blends of high and low molecular weight hydrophobically modified polysaccharides are solutioned together and heated to 150-190° F. for 30-45 minutes under constant mixing. Blends are structured based on viscosity targets for the particular application and are evaluated on the basis of oil and grease resistance (Kit Test, TAPPI T559.) Hydrophobic polysaccharide blends outperform either of the components separately for oil and grease resistance and viscosity.

### Blend Enhanced by Polyvinyl Alcohol

Blends of high and low molecular weight hydrophobically modified polysaccharides are solutioned together along with polyvinyl alcohol (PvOH). Any viscosity or level of hydrolysis can be used. Solutioning occurs by heating the hydrophobically modified polysaccharide and PvOH in water at 170E-205° F. for 0.5-2 hours. Blends are structured based on viscosity targets for the particular application and are evaluated on the basis of oil and grease resistance (Kit Test, TAPPI T559).

The coated paper products described herein were tested for repellency of grease and oil by a Kit Test (TAP PI T559). The Kit Test, well known in the paper and board coating art and was originally designed for testing paper and cardboard treated with fluorochemical sizing agents. The Kit Test involves the addition of a drop of a test solution onto the substrate after which the test solution is removed after 15 seconds and any darkening of the substrate (wetting) is recorded. The Kit Testing is repeated until the highest number kit solution that does not cause failure (wetting) is identified. Blends of hydrophobically modified polysaccharide and PvOH outperform hydrophobically modified polysaccharide alone.

The instant invention also includes a method for preparing a paper coating composition by blending of high and low molecular weight hydrophobically modified polysaccharides along with a PvOH and heating to 170-205 F for 30-45 minutes under constant mixing.

The materials and techniques used in the above method may be defined by those processes known in the art or described herein. A trace amount, as used herein, may constitute an amount of 10% or less by weight (i.e. solvent and base are less than 10% of the mixture). In another embodiment, trace amount may constitute an amount of 10-5%, 10-6% 10-7% 10-8% or 10-9%.

The present invention may be embodied in other forms without departing from the spirit and the essential attributes thereof, and, accordingly, reference should be made to the appended claims, rather than to the foregoing specification, as indicating the scope of the invention. The invention illustratively disclosed herein suitably may be practiced in the absence of any element which is not specifically disclosed herein.

What is claimed is:

1. A polysaccharide composition for producing a lower, more operative viscosity and maintaining and/or improving Kit performance comprising:
one or more modified polysaccharides;
one or more solvents; and
one or more bases.

2. The polysaccharide composition of claim 1 wherein the modified polysaccharides being a blend of low molecular weight modified polysaccharides and high molecular weight modified polysaccharides.

3. The polysaccharides composition of claim 2 wherein the low molecular weight polysaccharides having a molecular weight in the range of 10² to 10⁶ Daltons and the high molecular weight polysaccharides having a molecular weight in the range of 10⁶ to 10¹⁰ Daltons.

4. The polysaccharide composition of claim 1 wherein the polysaccharides are blended together in a mixer at a speed of 100 to 3000 rpm utilizing a low shear mixing head in order to achieve a desired viscosity and Kit level.

5. The polysaccharide composition of claim 1 wherein the composition achieves a viscosity level of 300 cps or less and a Kit level of 4 or more at a temp of 80-120° F.

6. The polysaccharide composition of claim 1 wherein one or more of the modified polysaccharides being an alkenyl succinic anhydride modified polysaccharide, a hydrophobically modified polysaccharide, or a combination thereof.

7. The polysaccharide composition of claim 1 wherein solvent being an organic solvent, water, or a combination thereof.

8. The polysaccharide composition of claim 7 wherein the solvent being water, methanol, ethanol, isopropyl alcohol, n-propanol, tetrahydrofuran, dimethyl sulfoxide, butanol or any combination thereof.

9. The polysaccharide composition of claim 1 wherein the solvent being present in only trace amounts and the base being present in only trace amounts, or the solvent is not present and the base being present in only trace amounts.

10. The polysaccharide composition of claim 1 further comprising a polyvinyl alcohol.

11. A process for producing an oil and grease resistant paper product comprising the steps of:
preparing a paper coating composition for the paper product, the paper coating composition comprising:
one or more alkenyl succinic anhydride polysaccharides;
one or more solvents; and
one or more bases.

12. The process of claim 11 wherein the alkenyl succinic anhydride polysaccharide having a monounsaturated alkene chain with 3, 4, 5, 6, 7, 8, 9, 10, 12, 14, 16, 18, 20, 22 or 24 carbon atoms, 3-5 carbon atoms, 6-18 carbon atoms, 19-24 carbon atoms, 3-24 carbon atoms or a combination thereof.

13. The process of claim 11 wherein the solvent being present in only trace amounts and the base being present in only trace amounts, or the solvent is not present and the base being present in only trace amounts.

14. The process of claim 11 wherein the solvent being water, methanol, ethanol, isopropyl alcohol, n-propanol, tetrahydrofuran, dimethyl sulfoxide, butanol or any combination thereof.

14. The process of claim 11 wherein the alkenyl succinic anhydride polysaccharide having a molecular weight in the range of 10² to 10¹⁰ Daltons and the base being sodium hydroxide, sodium carbonate, sodium bicarbonate, potassium hydroxide, calcium hydroxide, magnesium hydroxide, or any combination thereof.

15. The process of claim 11 wherein the paper coating composition further comprises polyvinyl alcohol.

16. A method for preparing a polysaccharide composition for producing a lower, more operative viscosity and maintaining or improve Kit performance comprising the steps of:
providing a mixing vessel;
adding one or more solvents to the mixing vessel;
adding one or more alkenyl succinic anhydride polysaccharides to the vessel to create a suspension;
stirring the suspension; and
heating the wet composition for a period of time after which said composition may be applied to a medium of choice.

17. The method of claim 16 wherein the alkenyl succinic anhydride modified polysaccharide having a monounsaturated alkene chain with 3, 4, 5, 6, 7, 8, 9, 10, 12, 14, 16, 18, 20, 22 or 24 carbon atoms, 3-5 carbon atoms, 6-18 carbon atoms, 19-24 carbon atoms, 3-24 carbon atoms, or a combination thereof, a molecular weight in the range of 10² to 10¹⁰ Daltons.

18. The method of claim 16 wherein the solvent being present in only trace amounts and the base being present in only trace amounts, or the solvent is not present and the base being present in only trace amounts.

19. The method of claim 16 wherein the solvent being water, methanol, ethanol, isopropyl alcohol, n-propanol, dimethyl sulfoxide, tetrahydrofuran, butanol or any combination of these solvents in a water solution.

20. The method of claim 16 further comprising the step of adding polyvinyl alcohol prior to heating the wet composition.
